(19) United States
(12) Patent Application Publication
(10) Pub. No.: US 2005/0204052 A1
(43) Pub. Date: Sep. 15, 2005

(54) Timing of quality of experience metrics

(75) Inventors: Ye-Kui Wang, Tampere (FI); Igor Curcio, Tampere (FI); Emre Aksu, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/057,118

(22) Filed: Feb. 11, 2005

(30) Foreign Application Priority Data
Feb. 13, 2004 (WO) PCT/IB04/00371

(51) Int. Cl. G06F 15/16

(52) U.S. Cl. 709/231

(57) ABSTRACT

Quality feedback in a streaming service wherein at least one media stream (101) is streamed to a client (601) and a quality feedback value is determined (304) according to at least one quality metric is improved by determining (305) a timestamp relating to said quality feedback value according to at least one timestamp metric, wherein for each of said at least one quality metrics, a corresponding timestamp metric is defined, and wherein each of said at least one timestamp metrics is based on a relative media playback time of said at least one media stream (101), and reporting (306) said quality feedback value and said related timestamp to a server (600). Said relative media playback time is preferably derived from RTP (102) timestamps, from a NPT provided by a RTSP (109), from timestamps of a RTCP or from timestamps of a SIP.

### FIELD OF THE INVENTION

This invention relates to a method, a computer program, a computer program product, a system, a client, a server and a protocol for quality feedback in a streaming service, wherein at least one media stream is streamed to a client.

### BACKGROUND OF THE INVENTION

Streaming, on the one hand, refers to the ability of an application settled in a client to play synchronized media streams like speech, audio and video streams in a continuous way while those streams are being transmitted to the client over a data network. On the other hand, streaming also refers to real-time low-delay applications such as conversational applications.

Applications that can be built on top of streaming services can be classified into on-demand and live information delivery applications. Examples of the first category are music and news-on-demand applications. Live delivery of radio and television programs are examples of the second category. Real-time low delay application are, for example, multimedia (video) telephony or Voice over IP and any type of conversational multimedia application.

Streaming over fixed Internet Protocol (IP) networks is already a major application today. While the Internet Engineering Task Force (IETF) and the World Wide Web Consortium (W3C) have developed a set of protocols used in fixed-IP streaming services, no complete standardized streaming framework has yet been defined. For Third Generation (3G) mobile communications systems according to the standards developed by the Third Generation Partnership Project (3GPP), the 3G Packet-switched Streaming Service (PSS, 3GPP TS 26.233, TS 26.234) fills the gap between the 3G Multi-media Messaging Service (MMS), for instance downloading applications and multimedia content, and conversational & streaming services.

The PSS enables mobile streaming applications, wherein the complexity of the terminals is lower than that required for conversational services, because no media input devices and encoders are required, and because less complex protocols can be used. The PSS includes a basic set of streaming control protocols, transport protocols, media codecs and scene description protocols.

FIG. 1 schematically depicts the PSS protocol stack 1 that controls the transfer of both streamable and non-streamable content between a content or media server and a client.

Streamable content 101, such as video, audio and speech, is first converted to the payload format of the Real-time Transport Protocol (RTP) 102 in an adaptation layer 103. Said RTP as defined by the IETF provides means for sending real-time or streaming data by using the services of an underlying User Datagram Protocol (UDP) 104, which in turn uses the services of an underlying IP protocol 105.

Non-streamable content 106, as for instance multimedia content which is not created for streaming purposes (e.g. MMS clips recorded on a terminal device), still images, bitmap and vector graphics, text, timed text and synthetic audio are transferred by the Hypertext Transfer Protocol (HTTP) 107, which uses the services of the underlying Transport Control Protocol (TCP) 108 and the further underlying IP 105.

Whereas for the non-streamable content 106, the built-in session set-up and control capabilities of the HTTP 107 are sufficient to transfer the content, in case of streamable content 101, an advanced session set-up and control protocol has to be invoked, for instance to start, stop and pause a streaming video that is transferred from the content server to the client via the RTP/UDP/IP. This task is performed by the Real-time Streaming Protocol (RTSP) 109, which may either use the underlying TCP 108 or the underlying UDP 104. RTSP requires a presentation description 110 at least to set-up a streaming session. Such a presentation description 110 may for instance be available in the form of a Session Description Protocol (SDP) file. Said SDP file contains the description of the session, for instance session name and author, the type of media to be presented, information to receive said media, as for instance addresses, ports, formats and so on, and the bitrate of the media.

If streaming content is to be viewed at the client side, for instance at a mobile terminal, the user of said terminal is first provided with a Universal Resource Identifier (URI) to specific content that suits his terminal. This URI may come from a WWW server, a Wireless Application Protocol (WAP) server, or may have been entered manually via the keyboard of the terminal. This URI specifies a streaming or RTSP server and the address of the content on that or another content server. The corresponding SDP file may now be obtained in a number of ways. It may be provided in a link inside the HTML page that the user downloads, for instance via an embed tag, or may also be directly obtained by typing it as a URI. The SDP file, i.e. the presentation description 110, then is transferred via the HTTP 107 as indicated in the middle column of the protocol stack of FIG. 1. Alternatively, it may also be obtained through RTSP 109 signalling, for instance by using the DESCRIBE method of the RTSP 109, as indicated by the right column of the protocol stack in FIG. 1. Note that the presentation description may equally well be transmitted by said RTP 102. However, for simplicity of presentation, this possibility was not included in FIG. 1.

The subsequent session establishment is the process in which the browser or the user of the mobile terminal invokes a streaming client to set up the session against the content server. The terminal is expected to have an active radio bearer that enables IP-based packet transmission at the start of session establishment signalling.

The subsequent set-up of the streaming service is done by sending an RTSP SETUP message for each media stream chosen by the client. This returns the UDP 104 and/or TCP 108 port to be used for the respective media stream. The client sends an RTSP PLAY message to the content server that then starts to send one or more streams over the IP network.

In order to offer service providers in PSS systems means to evaluate the end user streaming experience, streaming service quality metrics have been introduced in PSS systems, as presented in 3GPP Technical document (Tdoc) S4-030860: “Draft Rel-6 PSS Quality Metrics Permanent Document v.0.10”, which refers to 3GPP TSG-SA4 meeting #29 in Tampere, Finland, Nov. 24-28, 2003. The streaming client measures and feedbacks information on the quality of the actual streaming application to a streaming server, wherein said quality is defined in terms of said quality metrics. Said streaming server may for instance be an RTSP server, and said quality metrics may for instance be transported by using said RTSP and SDP.

Because the service is transparent to the type of RAN and CN, only the streaming client and the streaming server are impacted by the PSS quality metrics. One consequence of this is that the measurements may not rely on information from protocol layers below the RTP layer (e.g. UDP, IP, PDCP, SNDCP, LLC, RLC, MAC, Physical Layer).

The terminal in a PSS system with quality feedback is responsible to perform the quality measurements in accordance to the measurement definition, aggregate them into streaming client quality metrics and report the metrics to the streaming server. This requirement does not preclude the possibility for the streaming client to report raw quality measurements to be processed by the streaming server into quality metrics.

The streaming server is responsible to signal the activation of the streaming client's quality metrics reporting and to gather the streaming client's quality metrics. The streaming server may process the received streaming client's quality metrics to build aggregated quality metrics. E.g. it could receive a raw lost packets report and build the Min, Max, Avg and Std packet loss rate for a particular streaming client.

The following seven quality metrics are defined by Tdoc S4-030860:

Corruption Duration

Corruption duration is the time period from the first corrupted frame to the first subsequent good frame or the end of the reporting period (whichever is sooner). The unit of this metric is expressed in seconds, and can be a fractional value.

Rebuffering Duration

This metric is only applicable for audio, video and speech, and is not applicable to other media types. The unit of this metric is expressed in seconds, and can be a fractional value. Rebuffering is defined as any stall in playback time due to any involuntary event at the client side.

Initial Buffering Time

Initial buffering is the time from receiving the first RTP packet until playback starts. The unit of this metric is expressed in seconds, and can be a fractional value.

Number of Content Packets Lost in Succession

The number of content packets lost in succession per media channel.

Number of Bytes Presented to the Media Decoder

This parameter is the cumulative number of bytes presented to the media decoder.

Number of Detected Bit-Errors

This is the number of detected bit-errors at the application-level. Lower-level errors will be handled by the link layer (either dropped or propagated to the application layer).

Number of Corrected Bit-Errors

Number of corrected bit-errors at the application-level. Lower-level errors will be handled by the link layer (either dropped or propagated to the application layer).

The objective of the above quality metric definition is to obtain consistent measurements across content type, terminals, and types of Radio Access Network (RAN).

The constraints are to minimize the size of the quality metrics report that will be sent to the streaming server and, the complexity for the terminal.

The actual quality metrics feedback can be conveyed to the PSS server by using the SET_PARAMETER method of the RTSP with a feedback header 2 as depicted in FIG. 2, however, in particular cases, it is more efficient to use other methods to carry the information, as for instance the TEARDOWN message or the PAUSE message.

In the feedback header 2 of FIG. 2, Stream-url is the RTSP session or media control URL identifier for the feedback parameter. The Metrics field in the Parameters definition contains the name of the metrics/measurements (for instance corruption duration, etc.). The Value field indicates the results. There is the possibility that the same event occurs more than once during a monitoring period. In that case the metrics value can occur more than once, which indicates the number of events to the server. The optional Range field indicates the reporting period.

The optional Timestamp field in the feedback header 2 of FIG. 2 indicates the time when the event (or measurement) occurred or when the metric was calculated since the beginning of the session.

In Tdoc S4-030860, according to said Timestamp field, there exists no definition of the time base to be used and no definition for the “beginning of the session”.

It is thus unclear what time base is to be used for the determination of timestamps. There may be different possibilities, e.g. the absolute session time since the beginning of the session may be used. The absolute session time is the time when the session has happened, e.g. 12:20:22 to 13:20:22 on May 10^{th} of 2004. However, if the absolute session time is used, for instance as a timestamp for a report of a corruption, it is readily seen that this timestamp is not only related to the event that is to be reported, but is related to all events that have occurred before in said session. For instance, if a large initial buffering time was encountered, and then several rebufferings occurred during the session, a subsequent report on a corruption duration is assigned a timestamp that is delayed by said initial buffering and said rebufferings, and thus loses conciseness. The same holds if the streaming is paused by the client and then continued. If a reconstruction or analysis of this corruption shall be performed at the streaming server based on the quality report and the associated timestamp, all timestamps associated with preceeding events such as initial buffering, re-buffering, pausing, etc. have to be considered when analyzing the current timestamp.

Even when all timestamps of preceding events are available at said streaming server, such a reconstruction or analysis may not be possible at all, when the beginning of the session is not clearly defined. The beginning of the session may for instance be interpreted as the time when the first RTP packet is received by the streaming client, or the time when the first media frame is played, or otherwise.

Even when the time base and the session beginning time are clearly defined, the timestamp value of some of the defined metrics may still vary among different clients or different sessions of the same client. This is due to the fact that particularly the quality metrics that afford measurements at the client site depend on the processing power and the task load of the terminal the streaming client is set up in. For instance, even if the timestamp of the 4^{th} metric, i.e. the number of RTP packets lost in succession, is defined to be the exact time before the start of decoding, the time required by the terminal to arrive at said mark depends on said processing power and said task load.

As a result, the streaming server and the streaming client may have different interpretations of the reported quality metrics, and clients may report different quality metrics for the same streaming qualities. Consequently, due to the ambiguity of the reported timestamps, the streaming server cannot analyze the streaming quality correctly.

### SUMMARY OF THE INVENTION

In view of the above-mentioned problems, it is, inter alia, an object of the present invention to propose a method, a computer program, a computer program product, a system, a client, a server and a protocol that allow for a more precise and unambiguous reporting of the timing of quality feedback values in a streaming service.

It is proposed a method for quality feedback in a streaming service, wherein at least one media stream is streamed to a client, comprising determining a quality feedback value according to at least one quality metric, determining a timestamp relating to said quality feedback value according to at least one timestamp metric, wherein for each of said at least one quality metrics, a corresponding timestamp metric is defined, and wherein each of said at least one timestamp metrics is based on a relative media playback time of said at least one media stream, and reporting said quality feedback value and said related timestamp to a server.

Said at least one media stream may for instance be a continuous media stream that may contain video, audio or speech information that is continuously transmitted from a server, for instance a content server, to said client and is rendered on the terminal, in which said client is set up, in a synchronized manner. Alternatively, said at least one media stream may be a media stream of a real-time low delay application, as for example a multimedia (video) telephony stream or a Voice-over-IP media stream or any type of media stream in a conversational multimedia application. This streaming may take place in a streaming session, wherein several media streams may be concurrently streamed to said client. Said streaming may be based on a protocol, for instance the Real-time Transport Protocol RTP, and may be controlled by a further protocol, for instance a streaming protocol as the Real-time Streaming Protocol RTSP or the Session Initiation Protocol SIP, and may for instance allow to start, stop and/or pause the streaming. Said RTSP or SIP may be operated by protocol entities in said client and in said server and may be based on a Session Description Protocol SDP. Said server may be co-located or even be identical with the content server from which said media actually stems from, or may be a different instance. The quality of said streaming is determined at the client site according to said at least one quality metric, as for instance a corruption duration or a re-buffering event, and reported as a quality feedback value, for instance via said protocol that the streaming is based on or said protocol that controls the streaming. Said quality metric basically defines how said quality feedback value is calculated. Said at least one quality metric may be defined by said protocol that controls the streaming, and said at least one quality metric, for instance stemming from a set of several quality metrics defined by said protocol, may be negotiated between said client and said server before, during or even after the set-up of the session. For each of said at least one quality metrics, a respective timestamp metric is defined, for instance by said protocol that controls said streaming. Said timestamp metric basically defines how a timestamp that is associated with a quality feedback value that is defined by a quality metric is to be determined. Said at least one timestamp metric is based on a relative media playback time of said at least one media stream. Said relative media playback time represents the temporal progress of the playback of said at least one media stream uncoupled from any absolute time base, i.e. without integrating pause intervals or delay intervals of the playback as occurring during the streaming. Said relative media playback time thus may be related to the sampling time of the continuous media during its recording into a digital format. For instance, said relative media playback time may be represented by RTP timestamps provided by an RTP or by the Normal Play Time (NPT) provided by an RTSP, or by timestamps or timing information provided by an SIP or an RTCP (RTP Control Protocol (RFC 3550)). Said quality feedback value and the associated timestamp are then reported to said server, for instance via said protocol the streaming is based on or via said protocol that controls the streaming. If said protocol that controls said streaming is an RTCP or SIP, it may be preferred that said reported quality feedback value and related timestamp are captured or sniffed by an entity, for instance a network entity such as a Call State Control Function CSCF), in order to make quality measurements. Said timestamp may for instance be a mandatory or an optional parameter in an RTP/RTSP/RTCP/SIP header.

According to a first aspect of the present invention, to each quality feedback value, a timestamp can be assigned, wherein the timestamp metric of said timestamp is specifically defined for the quality metric of said quality feedback value. Thus the ambiguities arising from using a general timestamp metric for a class of different quality metrics is removed.

Furthermore, according to a second aspect of the present invention, the timestamp metric is based on a relative media playback time as time base and thus becomes independent of the absolute session time, independent of the delays caused by events that occurred before the actual event that is reported on and independent of the processing power and task load of the terminal the client is set up in. The use of the relative media playback time may also allow abandonment of the necessity of a definition of the beginning of a session.

According to the method of the present invention, it may be preferred that said streaming of said at least one media stream is based on a Real-time Transport Protocol RTP. Said RTP may be operated between said client and a content server and may use the services of a User Datagram Protocol UDP, which in turn may use the services of an Internet Protocol IP.

According to the method of the present invention, it may be preferred that said relative media playback time is derived from RTP timestamps that are provided in a header of at least one protocol data unit of said RTP. Said RTP timestamp may reflect the sampling instant of the first octet in an RTP protocol data unit (or packet), or, if stored data rather than data sampled in real time is transmitted within said at least one media stream, said RTP timestamp may be derived from a virtual presentation timeline derived from wallclock time to determine when the next frame or other unit should be presented.

According to the method of the present invention, it may be preferred that said streaming is at least partially controlled by a Real-time Streaming Protocol RTSP. Said RTSP may be based on a presentation description provided by a Session Description Protocol SDP. Said RTSP may be operated by said client and said server and may for instance allow for the starting, pausing and stopping of the streaming.

According to the method of the present invention, it may be preferred that said relative media playback time is derived from a Normal Play Time NPT that is provided by said RTSP. Said NPT may indicate the stream absolute position relative to the beginning of the presentation. Said NPT may be derived from RTP timestamps.

According to the method of the present invention, it may be preferred that said at least one quality metric defines said quality metric value to be a time duration of an event, and that said corresponding timestamp metric defines said timestamp to be the relative media playback time of a specific frame of said at least one media stream before said event has occurred.

According to the method of the present invention, it may be preferred that said event is a corruption duration and that said specific frame is the last good frame, in playback order, before the occurrence of said corruption.

According to the method of the present invention, it may be preferred that said event is a rebuffering duration and that said specific frame is the last played frame before the occurrence of said rebuffering.

According to the method of the present invention, it may be preferred that said event is a number of content packets lost in succession and that said specific frame is the last received frame, in playback order, before the occurrence of said succession of lost packets.

According to the method of the present invention, it may be preferred that said at least one quality metric defines said quality metric value to be a number of events, and wherein said corresponding timestamp metric defines said timestamp to be the relative media playback time of a specific frame of said at least one media stream before said number of events is measured.

According to the method of the present invention, it may be preferred that said number of events is a number of bytes presented to a media decoder, a number of detected bit-errors or a number of corrected bit-errors, and wherein said specific frame is the last decoded frame before said number of events is measured.

According to the method of the present invention, it may be preferred that said quality feedback value and said related timestamp are reported to said server via said RTSP. Said quality feedback value and said timestamp may for instance be contained in a header of an RTSP protocol data unit.

According to the method of the present invention, it may be preferred that said streaming is at least partially controlled by a Session Initiation Protocol SIP. It then may be preferred that said quality feedback value and related timestamp that are reported via said SIP are captured or sniffed by an entity, for instance a network entity such as a Call State Control Function CSCF), in order to make quality measurements.

According to the method of the present invention, it may be preferred that said relative media playback time is derived from a time basis that is provided by said SIP, in particular from SIP timestamps that are provided in a header of at least one protocol data unit of said SIP.

According to the method of the present invention, it may be preferred that said streaming is at least partially controlled by a Real-time Transport Control Protocol (RTCP). It then may be preferred that said quality feedback value and related timestamp that are reported via said RTCP are captured or sniffed by an entity, for instance a network entity such as a Call State Control Function CSCF), in order to make quality measurements.

According to the method of the present invention, it may be preferred that said relative media playback time is derived from a time basis that is provided by said RTCP, in particular from RTCP timestamps that are provided in a header of at least one protocol data unit of said RTCP.

According to the method of the present invention, it may be preferred that said reported quality feedback value and related timestamp are captured by an instance and used to analyze the quality of said streaming.

According to the method of the present invention, it may be preferred that said streaming service is a Packet-switched Streaming Service PSS in a 3G mobile communications system.

It is further proposed a computer program with instructions operable to cause a processor to perform the above-mentioned method steps.

It is further proposed a computer program product comprising a computer program with instructions operable to cause a processor to perform the above-mentioned method steps.

It is further proposed a system for quality feedback in a streaming service, comprising at least one server, and at least one client, wherein at least one media stream is streamed to said at least one client, wherein a quality feedback value is determined according to at least one quality metric, wherein a timestamp relating to said quality feedback value is determined according to at least one timestamp metric that is correspondingly defined for each of said at least one quality metrics and that is based on a relative media playback time of said at least one media stream, and wherein said quality feedback value and said related timestamp are reported to said at least one server.

It is further proposed a client in a streaming service, comprising means for receiving at least one media stream that is streamed to said client, means for determining a quality feedback value according to at least one quality metric, means for determining a timestamp relating to said quality feedback value according to at least one timestamp metric, wherein for each of said at least one quality metrics, a corresponding timestamp metric is defined, and wherein each of said at least one timestamp metrics is based on a relative media playback time of said at least one media stream, and means for reporting said quality feedback value and said related timestamp to a server. Said client may also be understood as one of at least two parties involved in a real-time low-delay application session as for instance multimedia (video) telephony or Voice over IP, which may for instance be controlled by SIP.

It is further proposed a server in a streaming service, wherein at least one media stream is streamed to a client, wherein a quality feedback value according to at least one quality metric is determined, and wherein a timestamp relating to said quality feedback value is determined according to at least one timestamp metric that is correspondingly defined for each of said at least one quality metrics and that is based on a relative media playback time of said at least one media stream, comprising means for receiving said quality feedback value and said related timestamp that are reported by said client to said server. Said server may also be understood as one of at least two parties involved in a real-time low-delay application session as for instance multimedia (video) telephony or Voice over IP, which may for instance be controlled by SIP.

It is further proposed a protocol to be used in a streaming service, wherein at least one media stream is streamed to a client, the protocol defining: at least one quality metric, and at least one timestamp metric for each of said at least one quality metrics, wherein each of said at least one timestamp metrics is based on a relative media playback time of said at least one media stream.

According to the protocol of the present invention, it may be preferred that said protocol is an RTSP in combination with a Session Description Protocol SDP.

According to the protocol of the present invention, it may be preferred that said protocol is an SIP in combination with a Session Description Protocol SDP.

According to the protocol of the present invention, it may be preferred that said protocol is an RTCP.

These and other aspects of the invention will be apparent from and elucidated with reference to the embodiments described hereinafter.

### BRIEF DESCRIPTION OF THE FIGURES

In the figures show:

FIG. 1: A schematic representation of a Packet-Switched Streaming Service (PSS) protocol stack according to the prior art,

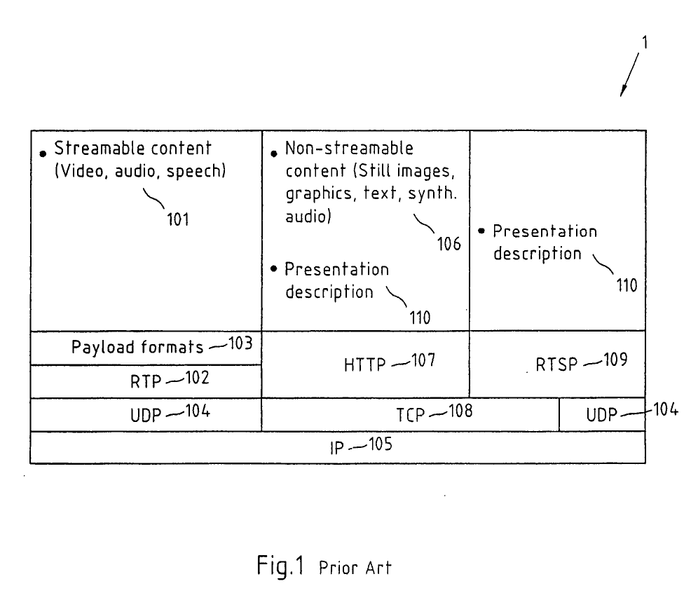

FIG. 2: a definition of a Real-time Streaming Protocol (RTSP) negotiation header according to the prior art,

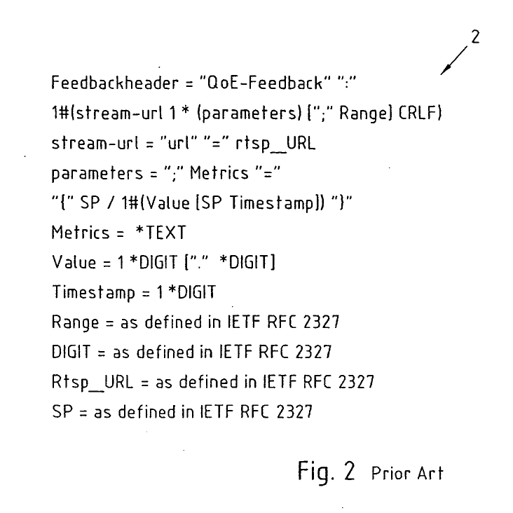

FIG. 3: a flowchart of the method of the present invention, and

FIG. 4: a schematic representation of a system according to the present invention.

### DETAILED DESCRIPTION OF THE INVENTION

The present invention removes the ambiguities in reporting of the timing of quality feedback values in a streaming service for both continuous multimedia applications such as synchronized video and audio transfer and rendering and for real-time low-delay applications such as conversational applications by proposing clearly and uniformly specified timestamp metrics (timestamp semantics) for each defined quality metric. The timestamp metrics are based on a relative media playback time, which may for instance be the Normal Play Time (NPT), which is available if a Real-time Streaming Protocol (RTSP) is used, or may be derived from Real-time Transport Protocol (RTP) timestamps, which are provided by the RTP and contained in each RTP header, or may be derived from the time basis or timestamps of a Real-time Transport Control Protocol RTCP or a Session Initiation Protocol SIP.

The RTCP is based on the periodic transmission of control packets to all participants in the session, using the same distribution mechanism as the data packets. The underlying protocol must provide multiplexing of the data and control packets, for example using separate port numbers with UDP. RTCP may particularly provide feedback on the quality of the data distribution. This is an integral part of the RTP's role as a transport protocol and is related to the flow and congestion control functions of other transport protocols. The feedback may be directly useful for control of adaptive encodings, but experiments with IP multicasting have shown that it is also critical to get feedback from the receivers to diagnose faults in the distribution. Sending reception feedback reports to all participants allows one who is observing problems to evaluate whether those problems are local or global. With a distribution mechanism like IP multicast, it is also possible for an entity such as a network service provider who is not otherwise involved in the session to receive the feedback information and act as a third-party monitor to diagnose network problems. This feedback function is performed by the RTCP sender and receiver reports. In particular, the RTCP may support or even provide timestamps.

SIP is an application-layer control protocol that can establish, modify, and terminate multimedia sessions (conferences) such as Internet telephony calls. SIP can also invite participants to already existing sessions, such as multicast conferences. Media can be added to (and removed from) an existing session. SIP transparently supports name mapping and redirection services, which supports personal mobility—users can maintain a single externally visible identifier regardless of their network location.

SIP is not a vertically integrated communications system. SIP is rather a component that can be used with other IETF protocols to build a complete multimedia architecture. Typically, these architectures will include protocols such as the RTP for transporting real-time data and providing QoS feedback, the Real-Time Streaming protocol RTSP for controlling delivery of streaming media, the Media Gateway Control Protocol MEGACO for controlling gateways to the Public Switched Telephone Network (PSTN), and the Session Description Protocol SDP for describing multimedia sessions. Therefore, SIP should be used in conjunction with other protocols in order to provide complete services to the users. However, the basic functionality and operation of SIP does not depend on any of these protocols.

SIP in particular provides a timestamp field in its headers. The Timestamp header field may for instance describe when one party sent a request to the other party.

When the SIP or RTCP is used, streaming takes place between two parties (e.g. set up in two terminals) of a session, and it might be useless that one party reports quality feedback values and related timestamps to the other party. It is thus advantageous to provide a network entity as for instance a Call State Control Function CSCF to sniff these reported quality feedback values and related timestamps and uses them to analyze the quality of the streaming between the two parties.

With the proposed timestamp metrics, different streaming servers and streaming clients will have the same interpretation of reported quality metrics, for instance Quality of Experience QoE metrics as in the Packet-switched Streaming Service (PSS) of 3G mobile communications systems or quality feedback in conversational applications, enabling correct analysis of streaming quality experiences. If the streaming server or a QoE metrics analyzer uses a method to map the NPT to actual time, it can make time-wise analysis about the session quality.

The timestamp metrics as defined in this invention for each quality metric defined in 3GPP Technical document S4-030860 will be presented below, wherein the notation NPT/RTP timestamp is to be understood in a way that if NPT (Normal Play Time) is available, NPT is used as relative media playback time, and if only RTP (Real-time Transport Protocol) timestamps are available, these are used as relative media playback time.

Corruption Duration

The timestamp indicates the time when the corruption has occurred. The value of the timestamp is equal to the NPT/RTP timestamp of the last good frame, in playback order, before the occurrence of the corruption. If there is no good frame before the corruption, the timestamp is set to 0.

The metric corruption duration is not only applicable to audio, video or speech media, but also to timed text streams as a medium.

Rebuffering Duration

The timestamp indicates the time when the rebuffering has occurred. The value of the timestamp is equal to the NPT/RTP timestamp of the last played frame before the occurrence of the rebuffering.

Initial Buffering Time

The timestamp semantics is unspecified, and the value of the timestamp is undefined.

Number of Content Packets Lost in Succession

The timestamp indicates the time when the succession of lost packets has occurred. The value of the timestamp is equal to the NPT/RTP timestamp of the last received RTP packet, in playback order, before the occurrence of the succession of lost packets. If there is no received RTP packet before the succession of lost packets, the timestamp is set to 0.

Number of Bytes Presented to the Media Decoder

The timestamp indicates the time when the number of bytes presented to the media decoder is measured. The value of the timestamp is equal to the NPT/RTP timestamp of the last decoded frame before the number of bytes presented to the media decoder is measured. If there is no decoded frame before the measurement, the timestamp is set to 0.

Number of Detected Bit-Errors

The timestamp indicates the time when the number of detected bit-errors is measured. The value of the timestamp is equal to the NPT/RTP timestamp of the last decoded frame before the number of detected bit-errors is measured. If there is no decoded frame before the measurement, the timestamp is set to 0.

Number of Corrected Bit-Errors

The timestamp indicates the time when the number of corrected bit-errors is measured. The value of the timestamp is equal to the NPT/RTP timestamp of the last decoded frame before the number of corrected bit-errors is measured. If there is no decoded frame before the measurement, the timestamp is set to 0.

As can be seen from the above timestamp metrics, the time instance of the event occurrence (corruption, rebuffering, initial buffering, or loss of a succession of RTP packets) or the time instance when the statistical value is measured (number of bytes presented to the media decoder, number of detected bit errors and number of corrected bits) is actually the location in the media stream measured in relative media playback time (NPT/RPT timestamps).

The timestamp of initial buffering time is unspecified because initial buffering happens only at the beginning of the session, before the start of the playback.

According to the reported quality metrics with the proposed timestamp information, the streaming server can mimic the stream playback or rendering that happened in the client; hence the streaming quality can be fully analyzed.

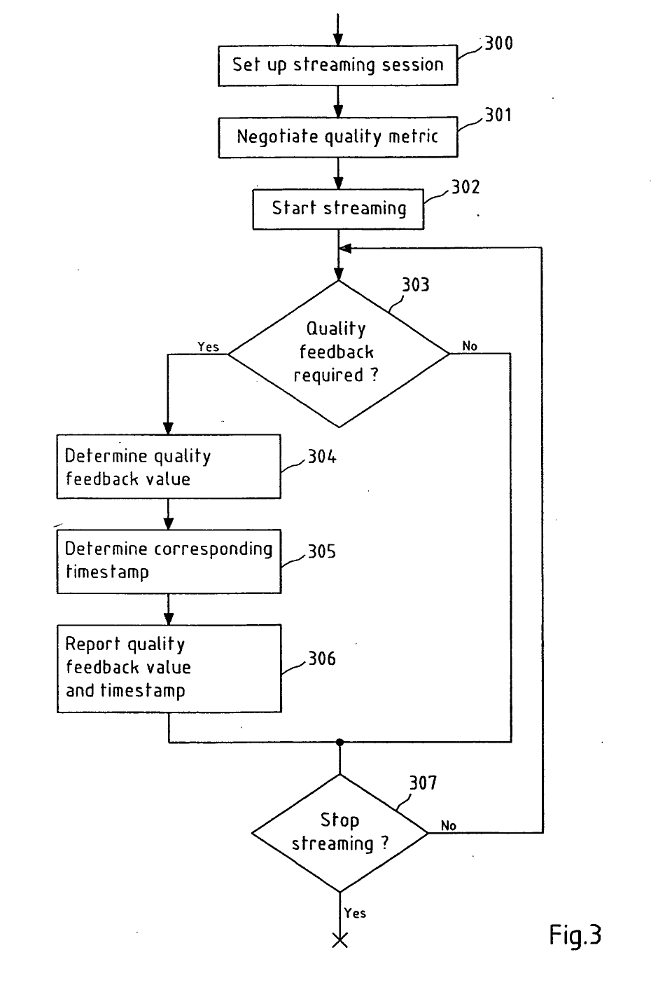

FIG. 3 depicts a flowchart of a method according to the present invention. In a first step 300, a streaming session is set up between a streaming client and a streaming server. In a step 301, one or more quality metrics are negotiated between the streaming client and the streaming server for use in the quality feedback procedure that is performed by the streaming client. Both said session set-up and negotiation may be based on an RTSP in combination with an SDP, or on an RTCP or SIP. Step 301 may also be performed together with step 300. A corresponding timestamp metric may be associated with each negotiated quality metric for the streaming session. In a step 302, the actual streaming is started, for instance when a media stream is transmitted to the streaming client and rendered on the terminal in which said streaming client is set up. During said streaming, in a step 303, it is monitored if a quality feedback is required or not. This may for instance be accomplished by continuously checking if an event, which has to be reported to the streaming server according to the negotiated quality metric, occurs or not. This may for instance be a rebuffering event. Alternatively, a periodical quality report may have been negotiated, for instance the periodical feed-back of the number of bytes presented to the media decoder in a certain time interval. In said step 303, both the event-driven and the periodical quality feed-back is triggered. If it is decided that quality feedback is required, in a step 304, a quality feedback value is determined according to each negotiated quality metric. Then a corresponding timestamp according to the timestamp metric that corresponds to each negotiated quality metric is determined in a step 305. Said step 305 may equally well be performed before the step 304. In any case, the quality feedback value and the corresponding timestamp are reported to the streaming server in a step 306, for instance via the RTSP, RTCP or SIP. After quality feedback, or if it is decided that no quality feedback is required, it is checked in a step 307 if streaming is to be stopped. If this is not the case, it is again checked in a step 303 if a new quality feedback is required or not.

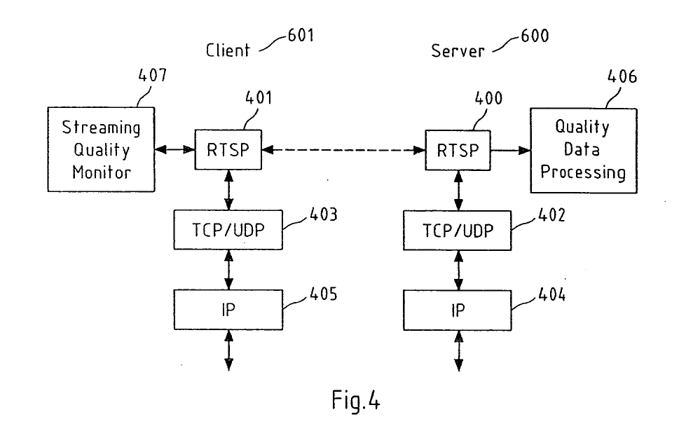

FIG. 4 schematically depicts the functional components of a system according to the present invention. This embodiment exemplarily refers to a PSS system that uses an RTSP to control the streaming. It is understood that equally well, the SIP could be used here with a slightly modified underlying protocol stack and with an additional network instance that sniffs or captures the quality feedbacks and timestamps that are sent from the client 601 (a first party) to the server 600 (a second party).

The PSS system in FIG. 4 comprises a streaming client 601 and a streaming server 600, wherein both client 601 and server 600 have at least one RTSP entity 401, 400 that is capable of operating the RTSP. The RTSP entities 400, 401 use the services of underlying protocol layers that are operated by further protocol entities, of which only the TCP/UDP entities 402, 403 and the IP entities 404, 405 are shown. The streaming client 601 is further connected to a streaming quality monitor instance 407, which monitors the quality of the actual streaming application in terms of the negotiated quality metrics and the corresponding timestamp metric and inputs monitored quality feedback values into said RTSP entity 401. Said streaming quality monitor may for instance be provided by the terminal, in which said streaming client is set up. The streaming quality monitor 407 then determines a timestamp according to the timestamp metric that corresponds to the used quality metric, and transfers said monitored quality feedback values and said corresponding timestamps, via the client RTSP 401, to the RTSP peer entity in the streaming server 600, where they are input into a quality data processing instance 406 for evaluation and analysis, which may for instance aim at improving the quality of the streaming application by enhancing the data rate of the streaming application if it is found that the re-buffering events become too frequent, or just aim at statistical quality data collection or charging or other aims.

The invention has been described above by means of a preferred embodiment. It should be noted that there are alternative ways and variations which will be evident to any person skilled in the art and can be implemented without deviating from the scope and spirit of the appended claims. In particular, the present invention is by no means restricted to application in 3G radio communications systems. It may equally well be deployed in all kinds of wired and wireless data transmission systems with parameter feedback.

1. A method for quality feedback in a streaming service, wherein at least one media stream (101) is streamed to a client (601), comprising:
determining (304) a quality feedback value according to at least one quality metric,
determining (305) a timestamp relating to said quality feedback value according to at least one timestamp metric, wherein for each of said at least one quality metrics, a corresponding timestamp metric is defined, and wherein each of said at least one timestamp metrics is based on a relative media playback time of said at least one media stream (101), and
reporting (306) said quality feedback value and said related timestamp to a server (600).

2. The method according to claim 1, wherein said streaming of said at least one media stream (101) is based on a Real-time Transport Protocol (RTP) (102).

3. The method according to claim 2, wherein said relative media playback time is derived from RTP timestamps that are provided in a header of at least one protocol data unit of said RTP (102).

4. The method according to claim 2, wherein said streaming is at least partially controlled by a Real-time Streaming Protocol (RTSP) (109).

5. The method according to claim 4, wherein said relative media playback time is derived from a Normal Play Time (NPT) that is provided by said RTSP (109).

6. The method according to claim 1, wherein said at least one quality metric defines a time duration of an event, and wherein said corresponding timestamp metric defines said timestamp to be the relative media playback time of a specific frame of said at least one media stream (101) before said event has occurred.

7. The method according to claim 6, wherein said event is a corruption duration and wherein said specific frame is a last good frame, in playback order, before occurrence of said corruption.

8. The method according to claim 6, wherein said event is a rebuffering duration and wherein said specific frame is a last played frame before occurrence of said rebuffering.

9. The method according to claim 6, wherein said event is a number of content packets lost in succession and wherein said specific frame is a last received frame, in playback order, before occurrence of said succession of lost packets.

10. The method according to claim 1, wherein said at least one quality metric defines a number of events, and wherein said corresponding timestamp metric defines said timestamp to be the relative media playback time of a specific frame of said at least one media stream (101) before said number of events is determined.

11. The method according to claim 10, wherein said number of events is a number of bytes presented to a media decoder, a number of detected bit-errors or a number of corrected bit-errors, and wherein said specific frame is a last decoded frame before said number of events is determined.

12. The method according to claim 4, wherein said quality feedback value and said related timestamp are reported to said server (600) via said RTSP (109).

13. The method according to claim 1, wherein said streaming is at least partially controlled by a Session Initiation Protocol (SIP).

14. The method according to claim 13, wherein said relative media playback time is derived from a time basis that is provided by said SIP, in particular from SIP timestamps that are provided in a header of at least one protocol data unit of said SIP.

15. The method according to claim 1, wherein said streaming is at least partially controlled by a Real-time Transport Control Protocol (RTCP).

16. The method according to claim 15, wherein said relative media playback time is derived from a time basis that is provided by said RTCP, in particular from RTCP timestamps that are provided in a header of at least one protocol data unit of said RTCP.

17. The method according to claim 1, wherein said reported quality feedback value and related timestamp are captured by an instance and used to analyze the quality of said streaming.

18. The method according to claim 1, wherein said streaming service is a Packet-switched Streaming Service PSS in a 3G mobile communications system.

19. A computer program with instructions operable to cause a processor to perform the method steps of claim 1.

20. A computer program product comprising a computer program with instructions operable to cause a processor to perform the method steps of claim 1.

21. A system for quality feedback in a streaming service, comprising:
at least one server (600), and
at least one client (601),
wherein at least one media stream (101) is streamed to said at least one client (601), wherein a quality feedback value is determined according to at least one quality metric, wherein a timestamp relating to said quality feedback value is determined according to at least one timestamp metric that is correspondingly defined for each of said at least one quality metrics and that is based on a relative media playback time of said at least one media stream (101), and wherein said quality feedback value and said related timestamp are reported to said at least one server (600).

22. A client (601) in a streaming service, comprising:
means (401, 403, 405) for receiving at least one media stream (101) that is streamed to said client (601),
means (401, 407) for determining a quality feedback value according to at least one quality metric,
means (401) for determining a timestamp relating to said quality feedback value according to at least one timestamp metric, wherein for each of said at least one quality metrics, a corresponding timestamp metric is defined, and wherein each of said at least one timestamp metrics is based on a relative media playback time of said at least one media stream (101), and
means (401) for reporting said quality feedback value and said related timestamp to a server (600).

23. A server (600) in a streaming service, wherein at least one media stream (101) is streamed to a client (601), wherein a quality feedback value according to at least one quality metric is determined, and wherein a timestamp relating to said quality feedback value is determined according to at least one timestamp metric that is correspondingly defined for each of said at least one quality metrics and that is based on a relative media playback time of said at least one media stream (101), comprising:
means (400) for receiving said quality feedback value and said related timestamp that are reported by said client (601) to said server (600).

24. A protocol to be used in a streaming service, wherein at least one media stream (101) is streamed to a client (601), the protocol defining:
at least one quality metric, and
at least one timestamp metric for each of said at least
one quality metric,
wherein each of said at least one timestamp metrics is based on a relative media playback time of said at least one media stream (101).

25. The protocol of claim 24, wherein said protocol is a Real-Time Streaming Protocol (RTSP) (109) in combination with a Session Description Protocol (SDP) (110).

26. The protocol of claim 24, wherein said protocol is an Session Initiation Protocol (SIP).

27. The protocol of claim 24, wherein said protocol is an RTP (Real-time Transport Protocol) Control Protocol (RTCP).
